(19) United States
(12) Patent Application Publication
(10) Pub. No.: US 2009/0112733 A1
(43) Pub. Date: Apr. 30, 2009

(54) Method and apparatus for a retail in-store bidding system

(76) Inventor: Gabriel Horowitz, (US)

Correspondence Address: GABRIEL HOROWITZ, HANAFA 714, P.O. BOX 2336, KADIMA, 60920, IL

(21) Appl. No.: 11/867,087

(22) Filed: Oct. 4, 2007

(51) Int. Cl. G06Q 30/00

(52) U.S. Cl. 705/27

(57) ABSTRACT

This invention proposes a new retail approach supported by a system (a process and an apparatus) featuring a series of new capabilities that change the basic retail paradigm where, by utilizing this new approach, the seller and the buyer interact via a new system where the buyer “proposes” (bidding) a price for a product and/or a service and the buyer may accept or not this “proposal” through a dynamic algorithm embedded in the system's logic. If the bid is accepted, the buyer collects the product or receives the services on the spot, bringing the “instant satisfaction” dimension into the picture.

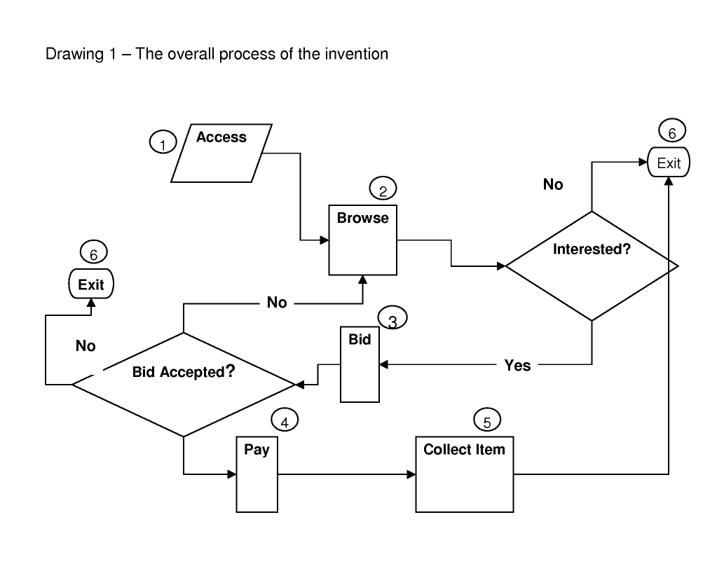

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The application for this invention is for an innovative method and apparatus (THE SYSTEM) that allows retailers and service providers to improve their revenues and margins while providing a better customer experience in the store. THE SYSTEM allows customers within the store to bid for the items they would like to purchase by manually entering the price they are willing to pay for it. Consequently, this bid price is to be accepted or rejected based upon a bidding algorithm, which can be configured through THE SYSTEM and fed with retail data (cost, inventory level, competition, margins, etc) to perform its calculations.

### Purchasing Decision—The Critical Moment in Retail

As an introductory explanation, we would like to present a classical and frequent retail scenario, focusing on the critical moment in which the purchase decision is made.

A customer considers purchasing a brand name suit which he knows for a fact the market price of is around $5,000. He browses the store and finds it. Based on the neuron-psychological reaction, the customer thinks to himself: “I want to have it, and I want to have it now, and I would've purchased it now if the price was $2,500”. On the other hand, the retailer would like to reduce the stock on that specific item, but is not authorized by the brand-name manufacturer to publish a 50% discount so that it preserves the positioning of the brand.

Another example from the service provider or airline market is: after a long and tiring day of meetings an airliner traveler thinks to himself while checking in via the self check-in machines: “I would upgrade to business or first if the price was lower than the regular last minute upgrade price”. Using THE SYSTEM, the airline can offer the available seats through the bidding method with the benefit for both the passenger who may pay the price he can afford and the airline may be filling up the higher paid business class seats that otherwise would be empty.

The method described in this patent comes to solve exactly this situation and other typical purchasing decision “moments”.

The utilization of THE SYSTEM proposed in this invention will allow the customer to enter a dedicated area of the store using one of the methods described below. Once inside, he will be allowed to bid only once for a specific item. If according to the algorithm designed in the apparatus, the store is interested to sell it for the bidding price, the customer can take the suit with him right away. If the price is unacceptable, the customer cannot bid again and will have to wait for another opportunity on another day. As opposed to currently used internet-based bidding systems, in this case the customer has immediate satisfaction and doesn't have to wait for the purchased item to arrive at his home several days later, and he can find out immediately if his bid has been accepted or not.

### Scientific Background of the Invention

The scientific research made in the area of purchasing decision has inspired the development of the present invention. A recent article: Neural Predictor of Purchases—Knutson et al. Neuron 53, Jan. 4, 2007, Elsevier Inc. has established a clear behavior pattern while a customer is facing a purchasing decision. There are four stages—Product, Price, Choice, Fixate.

This study establishes that a certain part of the brain (the emotional part) is activated when the customer browses the store that plays a role of attracting the customer to the product and creating a sort of a “link” to it.

The price factor plays a crucial role in the purchasing decision and in the neurological process, since it functions as a “switch” between the “emotional” side of the brain and the “rational” side, which will eventually decide whether or not to proceed with the purchasing decision.

The objective of the present invention is to modify this process and put the customer “in charge” of the price factor and “pass the ball” to the retailer in the decision process.

### Industry and Operational Background

According to recent survey and reports from the National Retail Federation (NRF) in the Unites States of America, shoppers are and will be very comfortable with technology while shopping online and at the store. For instance, teens use technology to socialize, stay connected and gather information. According to a recent survey from the NRF, more than 90 percent of teens in the US carry a cell phone and they will use it in a shopping process. Twenty five percent of teens used a cell phone or PDA to access the Internet while in a store and almost a third bought something using their cell phone. Teens have also come to accept and expect technology in the store and are active users of various tools. For example, 65 percent reported using self check-out and 70 percent have used a price check tool. Teens, however, do not see technology as a differentiator that would draw them to a particular store. These young shoppers were more concerned with whether the technology added value to the shopping experience, consistently worked as expected and that sales associates knew how to use the devices. On the other hand, boomers are moving online, and a large portion of this population shop primarily offline today and the in-store experience is a key motivator for which stores they frequent. Once in the store, boomers are extremely demanding. They have little time or tolerance for service disruptions. Very often, one single bad experience will drive them away from that retailer forever. Most of the issues, as mentioned by boomers, deal with poor service from sales associates or breakdowns in the overall shopping process that lead to excessive delays.

Therefore, in this world of teens and boomers, with their own shopping needs and requirements, some retailers specialize and address only teens, while others target only boomers. Still, some retailers may cater to both. By tailoring their customer strategies to their value proposition, retailers can tap into new and existing opportunities for growth, and deliver more relevant shopping experiences.

Advanced retailers nowadays, consider innovative strategies to address this new shopping paradigm. These strategies focus on two critical pillars. One pillar is based on the sales personnel and the strategy requires an enhancement of in-store execution by adjusting staffing working models and developing empowered and motivated sales staff, in order to reduce the detrimental impact of service failures that can drive away both boomers and teens.

The other pillar is all about technology in the store which creates convenience and innovation in the shopping experience and keeps both boomer and teen shoppers excited and engaged in the process. The invention presented in this patent deals with this second pillar. THE SYSTEM will generate this effect of newness in the shopping experience and will definitely enhance the in-store customer experience to reach new and unknown limits.

### BRIEF SUMMARY OF THE INVENTION

The invention comes to solve both the problems of the retailers (over stock, left stock, not publishing sale prices on exclusive items to prevent cannibalization) and the consumers (paying the price they believe is right) by means of an in-store bidding system.

It is advantageous in many retail and other applications involving a transaction between a business and its customers to enable them to bid for the price they are willing to pay for a specific product or service. Traditionally, the purchasing process has been the same in the modern era: the retail or the service provider established the price and the potential purchaser made the decision if he or she were willing to buy the goods based on several parameters such as previous knowledge of the value of the product or service, immediate need, etc. Examples include retail stores, hotels, e-commerce, restaurants, financial institution charges, parking lots of shopping malls, etc.

The above mentioned traditional purchase and sell method, creates several problems and challenges to retailers and service providers as well as customers:

a. For retailers, some well known issues and problems are those of margin erosion, markdowns, competitive differentiation, overstock and out of stock (inventory management), space allocation and attracting high-paying customers to the store, creating a differentiator and a more exclusive-type experience.
b. For customers, the old purchasing process has resulted in a poor and boring customer experience because stores are nothing more than glorified warehouses.

Until now, basically the purchase and sale process has been an exchange of merchandise or service based on a price that is always established by the seller.

Therefore, a clear opportunity exists in modifying the current approach and introducing a new one that will help both customers and retailers to overcome most of the problems as described above.

This innovative approach is based on an in-store bidding system that enables potential customers to bid their own price for selected products and services. After the bidding is finalized, THE SYSTEM responds to the customer as to whether his or her bid was accepted or rejected based on the output of a proprietary and configurable algorithm embedded in THE SYSTEM, which allows the retailer to manage critical retail parameters such as inventory management, price optimization, margin ranges, etc.

This new approach provides a more lucid and enriching purchasing experience for the customer, while at the same time enables the retailer to manage more efficiently margins and inventory.

### BRIEF DESCRIPTION OF THE SEVERAL VIEWS OF THE DRAWING

Drawing 1—shows the process of the in-store bidding system as presented by the invention.

### DETAILED DESCRIPTION OF THE INVENTION

The invention is based on two main components: the process itself and the apparatus and algorithm that support it.

The following sections describe in detail both components.

### Detailed Description of the Process

The description of the process of the invention is described below with reference to the accompanying drawings:

Drawing 1 is a diagram of the overall process;

### 1. Access

The access to the bidding store or the bidding section within the store will be controlled by a concierge and limited to the customers in possession of one of the store accepted payment methods:
a. Credit Card
Access by means of a credit card will:
   Permit the store to identify the customer at the entry point.
      Identification of the customer to allow him to bid for a specific item only once within a specific period of time (24 hs, a week, a month, etc)
      The identification at the entry will allow to perform cross/up and promotional sales activities.
      Better market segmentation
      Improve customer satisfaction through better service and approach the identification
   Permit to charge an entry fee as:
      An additional revenue source
      A “Filter” to differentiate committed customers from “just play around/just curious” customers
      Initiate the purchasing transaction
      For a limited amount: Customer wants to spend only a fixed amount of money and at the end of the transaction the store reconciliates the final purchasing amount with the initial amount
      For an “open” amount: Customer will close the transaction only at the end of the purchasing process
         b) Other methods

The process would be the same as with the credit card, but based on other types of cards such as:
Bidding Card (plastic card with a magnetic strip)
Bidding Card (plastic card with a bar code)
Bidding Coupon (paper/carton card with a magnetic strip)
Bidding Coupon (paper/carton card with a bar code)
Bidding Code (paper)
Chip Card (plastic card with a chip)
Debit Card
Bidding Chip Card
Department Store Card
Promotional Pass
Etc.

The store issued cards may be charged to the customer's credit/debit card or purchased in cash from the concierge at the store or on a Cash Exchange Machine, for a limited amount of money. At the end of the process, the remaining balance will be returned to the customer either to his credit/debit card account or by cash.

### 2. Browse

Browsing of the products or services will be done either via computerized displays within the bidding section of the store or by looking at actual samples of the product as in any regular retail environment allowing for the “touch-and-feel” experience produced by the neuro-psychological reaction as described in the Background.

### 3. Bid

Bidding is done by means of the same entry method used to access the bidding section of the store. The card will be used to activate the machine, select the items and bid the price. As a default, the card will be automatically charged in case the bid is accepted. The algorithm and mechanism is described in section 0.

### 4. Pay

If the bid is accepted by the machine, the payment is done automatically from the used card with a previous confirmation that the cardholder has enough funds in his/her account. At the end of the payment process an invoice is issued for the customer to collect the item at the concierge's or the customer service desk.

### 5. Collect Item/Receive Service

Once the sale is closed, THE SYSTEM automatically triggers the storage room to prepare the item/s to be delivered and eventually handed out to the customer against a final purchasing receipt. This service can be enhanced by bringing the items directly to the concierge section and save precious time to the customer, allowing the customer to be offered a drink or a coffee, depending on the retailer's customer service policy/strategy.

### 6. Exit

### Detailed Description of the Apparatus and the Algorithm

### The Apparatus:

The apparatus is composed by a touch screen display (similar to those used by retailers for their Point of Sales), or a the newly developed “surface” computing table, and a credit card slide and also a slot to utilize chip cards or bar coded coupons.

The software used to activate and operate the display provides the end-user a means to enter his or her bid for the item he or she is interested in. The information about the item is obtained by the chip card used to browse or from a specific search engine to locate the item.

Once the item is perfectly and unequivocally identified by the customer, the customer will receive, before the final bid, a prompt to accept that this is the item targeted to bid on, and finally a list of potential disclaimers imposed by the retailer.

Once the series of disclaimers are accepted, the customer will be able to enter the bid price or the price range by entering the price or a price range manually (depending on the bidding mode/scheme offered by the retailer).

After a final price or a price range is established by the customer, the customer will OK the transaction to be processed by the algorithm.

The processing of the bid is performed by the algorithm in conjunction with the rest of the retail applications via an integration configuration.

The credit card slide and the chip card slot are connected via a network to external credit card companies.

### The Algorithm:

The algorithm is based on a series of price optimization models that calculate how demand varies at different price levels (price elasticity). This output is combined with information on costs, inventory levels, product volumes, promotion data, competitor's prices, store performance and margin factors, to recommend prices that will improve profits and other specific business requirements. These prices are loaded for certain scenarios that can be readily customized according to the retailer current and future needs. It is important to emphasize that the algorithm is integrated with other retail systems to enable near real-time interaction between the different systems.

This integration is based on a service oriented architecture that provides a high degree of flexibility to modify business process as retail conditions change and to adapt customer behavior and response to maximize revenue and profit targets.

1. A method for bidding for retail merchandise and services while the bidder is physically located in a retail store or the bidder is bidding from a remote location. The method is driven by a specifically designed computer program and is comprising the steps of:
a) Browsing for products and/or services offered by the retailer through computerized displays by:
i. Looking at the actual pictures of the products that are sold in the store accompanied by their descriptions, specifications and technical details.
ii. Reading the descriptions of the offered services accompanied by their specific details and conditions related to those services.
b) Selecting a list of products and/or services that later on, a bid will be placed upon them by the customer
c) Bidding for the selected products and/or services by selecting bidding options, price ranges and, entering the desired price or price range through a graphical user interface driven by an algorithm specifically designed for bidding purposes.
d) Paying for the products and/or services whose bid was accepted by the retailer.
e) Collecting the products bought through the in-store bidding process.
f) Analyzing bidding trends by the retailer through different analytical capabilities embedded in the specifically designed computer program.
g) Modifying bidding options by the retailer through different features coded in the bidding algorithm.

2. A method for bidding for an upgrade for an airline ticket while the traveler checks in for his or her flight at the airport or checks in for his or her flight from a remote location. The method is driven by a specifically designed computer program and is comprising the steps of:
a) Browsing for upgrade options offered by the airline through a computerized display listing these options.
b) Selecting an upgrade option that later on, a bid will be placed upon them by the traveler.
c) Bidding for the selected upgrade entering the desired price or price range through a graphical user interface driven by an algorithm specifically designed for bidding purposes.
d) Paying for the upgrade in case the bid was accepted by the airline.
e) Collecting the boarding card with the upgrade.
f) Analyzing bidding trends by the airline through different analytical capabilities embedded in the specifically designed computer program.
g) Modifying bidding options by the airline through different features coded in the bidding algorithm.

3. A method for bidding for additional services offered by a hotel. The method is driven by a specifically designed computer program and is comprising the steps of:
a) Browsing for upgrade options at check in time or at any time of the through a computerized display listing these options.
b) Selecting an upgrade option that later on, a bid will be placed upon them by the traveler.
c) Bidding for the selected upgrade entering the desired price or price range through a graphical user interface driven by an algorithm specifically designed for bidding purposes.
d) Paying for the upgrade in case the bid was accepted by the hotel.
e) Analyzing bidding trends by the hotel through different analytical capabilities embedded in the specifically designed computer program.
f) Modifying bidding options by the hotel through different features coded in the bidding algorithm.
